(19) United States
(12) Patent Application Publication
(10) Pub. No.: US 2019/0116256 A1
(43) Pub. Date: Apr. 18, 2019

(54) HYBRID APPLICATION LAUNCHER FOR MOBILE DEVICES

(71) Applicant: Verizon Patent and Licensing Inc., Arlington, VA (US)

(72) Inventors: Masudur RAHMAN, Somerset, NJ (US); Sonal R. GANDHI, Bridgewater, NJ (US); Bharadwaj VEMURI, Bear, DE (US)

(21) Appl. No.: 15/787,032

(22) Filed: Oct. 18, 2017

(51) Int. Cl. H04M 1/725; G06F 3/0488; G06F 3/0482; G06F 3/0481; H04W 4/02

(52) U.S. Cl. CPC H04M 1/72569; H04M 1/72586; H04W 4/02; G06F 3/0482; G06F 3/04817; G06F 3/0488

(57) ABSTRACT

A device may determine a group of dynamic applications to which to provide access. The device may configure a set of dynamic application parameters to provide access to the group of dynamic applications. The set of dynamic application parameters may be configured based on one or more static applications to be provided, by a mobile device, with the group of dynamic applications. The device may provide access to the group of dynamic applications based on configuring the set of dynamic application parameters.

### BACKGROUND

A mobile application (or “app”) is a computer program designed to run on a mobile device such as a smartphone or a tablet computer. Such mobile devices may be sold with some mobile applications bundled as pre-installed software, such as a web browser, an email client, a calendar, or the like. Mobile applications that are not preinstalled on a mobile device may be available through distribution platforms, which may be operated by an owner of an operating system of the mobile device.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for providing access to applications.

### DETAILED DESCRIPTION OF PREFERRED EMBODIMENTS

The following detailed description of example implementations refers to the accompanying drawings. The same reference numbers in different drawings may identify the same or similar elements.

A mobile device may include a set of static applications stored in a data structure of the mobile device. Static applications may provide a set of functionalities for the mobile device, such as a calculator functionality, a calendar functionality, a game playing functionality, a media playback functionality, a messaging functionality, and/or the like. Some static applications are loaded onto the mobile device before the mobile device is purchased by a user, such as by an original equipment manufacturer (OEM), a network operator, and/or the like. Other static applications are downloaded onto the mobile device after purchase by the user. For example, a user may utilize a preloaded application store (or “app store”) type of static application to identify and cause the mobile device to download a game playing type of static application.

However, as a quantity of preloaded applications on the mobile device increases, the mobile device may lack memory resources to download additional static applications for use on the mobile device. Moreover, some static applications may lack relevance to a use case of the user. For example, a user who is a child may not need a spreadsheet application preloaded onto the mobile device. Additionally, preparing an application for preloading may result in an excessive lifecycle time to release the mobile device. In other words, delays to ensure time for testing the preloaded static application on the mobile device before release of the mobile device may be excessive. Further, providing an application for download after release of the mobile device may result in excessive utilization of network resources, and may further deplete memory resources of the mobile device.

Some implementations, described herein, may enable hybrid utilization of static applications and dynamic applications on a mobile device. For example, some implementations described herein may provide a dynamic application manager in a dynamic application cloud environment to selectively provide access to dynamic applications executing in the dynamic application cloud environment. In this case, a mobile device may receive access to the dynamic applications and may provide, via a single user interface, information identifying the dynamic applications and static applications stored by the mobile device in the single user interface. In this way, the dynamic application manager enables seamless deployment of applications by application providers (e.g., OEMs, network operators, etc.) to mobile devices that also store static applications. Moreover, based on providing some applications as dynamic applications, an amount of network traffic, a memory utilization, a device lifecycle time, and/or the like may be reduced relative to providing each application as a static application (e.g., as a preload or a download). Moreover, based on providing some applications as static applications, an amount of network traffic may be reduced relative to providing each application as a dynamic application.

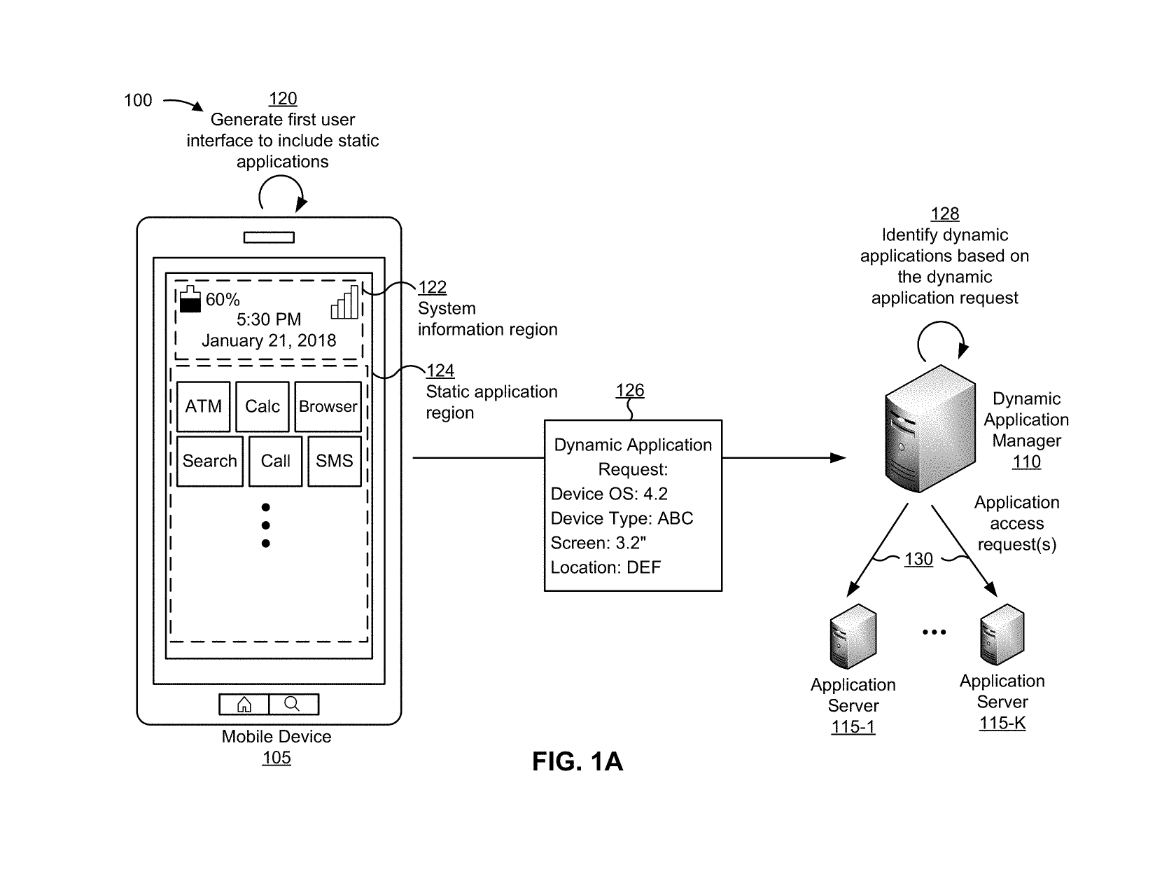

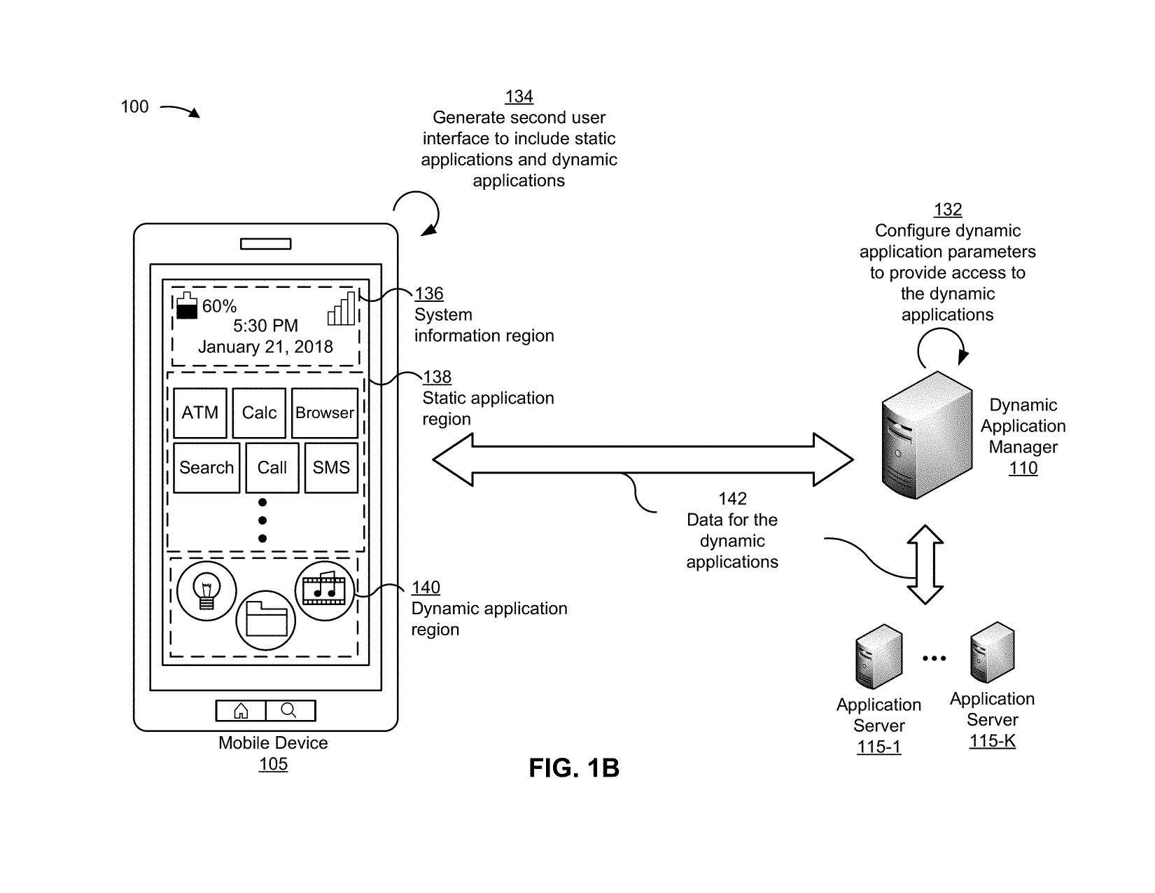

FIGS. 1A and 1B are diagrams of an overview of an example implementation 100 described herein. As shown in FIGS. 1A-1B, example implementation 100 may include mobile device 105, dynamic application manager 110, and application servers 115-1 to 115-K.

As shown in FIG. 1A, and by reference number 120, mobile device 105 initially generates a first user interface to include static applications (e.g., to display icons representing the static applications). The user interface may include system information in system information region 122, and may include information identifying static applications in static application region 124, where static application region 124 is separate (e.g., displayed at a different location of a layout of the first user interface) from system information region 122. As shown by reference number 126, after connection to a network, mobile device 105 provides a dynamic application request (e.g., identifying a device operating system, a device type, a device user interface size, a device location, etc.) to access one or more dynamic applications (e.g., applications that may be executed in a cloud environment).

As further shown in FIG. 1A, and by reference number 128, dynamic application manager 110 receives the dynamic application request and identifies a group of dynamic applications based on the dynamic application request. As an example, at a theme park, mobile device 105 may detect a Bluetooth beacon, and may transmit a dynamic application request to dynamic application manager 110 identifying the beacon for the theme park. In another example, mobile device 105 may determine a location via another technique, such as using a global positioning system module, detecting another type of signal or beacon, and/or the like. In this case, dynamic application manager 110 may identify a set of applications provided by the theme park operator and loaded into a cloud computing environment. For example, the applications may include an application related to ride wait time, an upcoming attractions application, an expedited line access purchase application, etc. In this way, dynamic application manager 110 uses information relating to mobile device 105 to provide contextually relevant applications to a user of mobile device 105.

As shown by reference number 130, dynamic application manager 110 communicates with application servers 115 (e.g., computing resources of a cloud computing environment) to provide access to the applications for mobile device 105. For example, dynamic application manager 110 may communicate with application servers 115 to allocate computing resources, instantiate an executing instance of an application, and/or the like. Based on dynamically allocating resources for the applications, dynamic application manager 110 reduces a utilization of computing resources relative to a static computing resource allocation to support each mobile device 105 even when the applications are not contextually relevant for a particular mobile device 105.

As shown in FIG. 1B, and by reference number 132, dynamic application manager 110 configures dynamic application parameters to provide access to the dynamic applications. The dynamic application parameters may include a percentage of user interface space to allocate to dynamic applications, a user interface layout to display both dynamic and static applications, an order of applications for display, iconography for applications, and/or the like. Continuing with the example of the theme park introduced with reference to FIG. 1A, dynamic application manager 110 may, for example, resize applications based on a size of a user interface of mobile device 105, determine a layout for including applications in a user interface of mobile device 105, determine an ordering of applications, such as based on a characteristic of the user (e.g., order an activities application first for a child user, order a payment application first for an adult user, etc.).

As further shown in FIG. 1B, dynamic application manager 110 provides access to the dynamic applications to mobile device 105. As shown by reference number 134, mobile device 105 is caused to generate a second user interface to include static applications and dynamic applications. As shown by reference number 136, the second user interface may include system information in a system information region. As shown by reference number 138, the second user interface may include static applications in a static application region that is separate from the system information region. As shown by reference number 140, the second user interface may include dynamic applications in a dynamic application region that is separate from the static application region and separate from the system information region. As shown by reference number 142, dynamic application manager 110 enables communication of data between mobile device 105 and application servers 115 to enable use of the dynamic applications.

In this way, the dynamic application manager enables seamless deployment of applications by application providers (e.g., OEMs, network operators, etc.) to mobile devices that also store static applications. Moreover, based on providing some applications as dynamic applications, an amount of network traffic, a memory utilization, a device lifecycle time, and/or the like may be reduced relative to providing each application as a static application (e.g., as a preload or a download). For example, based on operating dynamic applications in a cloud computing environment, data download, bandwidth usage, device memory usage, and/or the like may be reduced, application speed may be improved, and/or the like. Moreover, based on providing some applications as static applications, an amount of network traffic may be reduced relative to providing each application as a dynamic application.

As indicated above, FIGS. 1A and 1B are provided merely as an example. Other examples are possible and may differ from what was described with regard to FIGS. 1A and 1B. For example, there may be additional devices and/or networks, fewer devices and/or networks, different devices and/or networks, or differently arranged devices and/or networks than those shown in FIGS. 1A and 1B. Furthermore, two or more devices shown in FIGS. 1A and 1B may be implemented within a single device, or a single device shown in FIGS. 1A and 1B may be implemented as multiple, distributed devices. Additionally, or alternatively, a set of devices (e.g., one or more devices) of example implementation 100 may perform one or more functions described as being performed by another set of devices of example implementation 100.

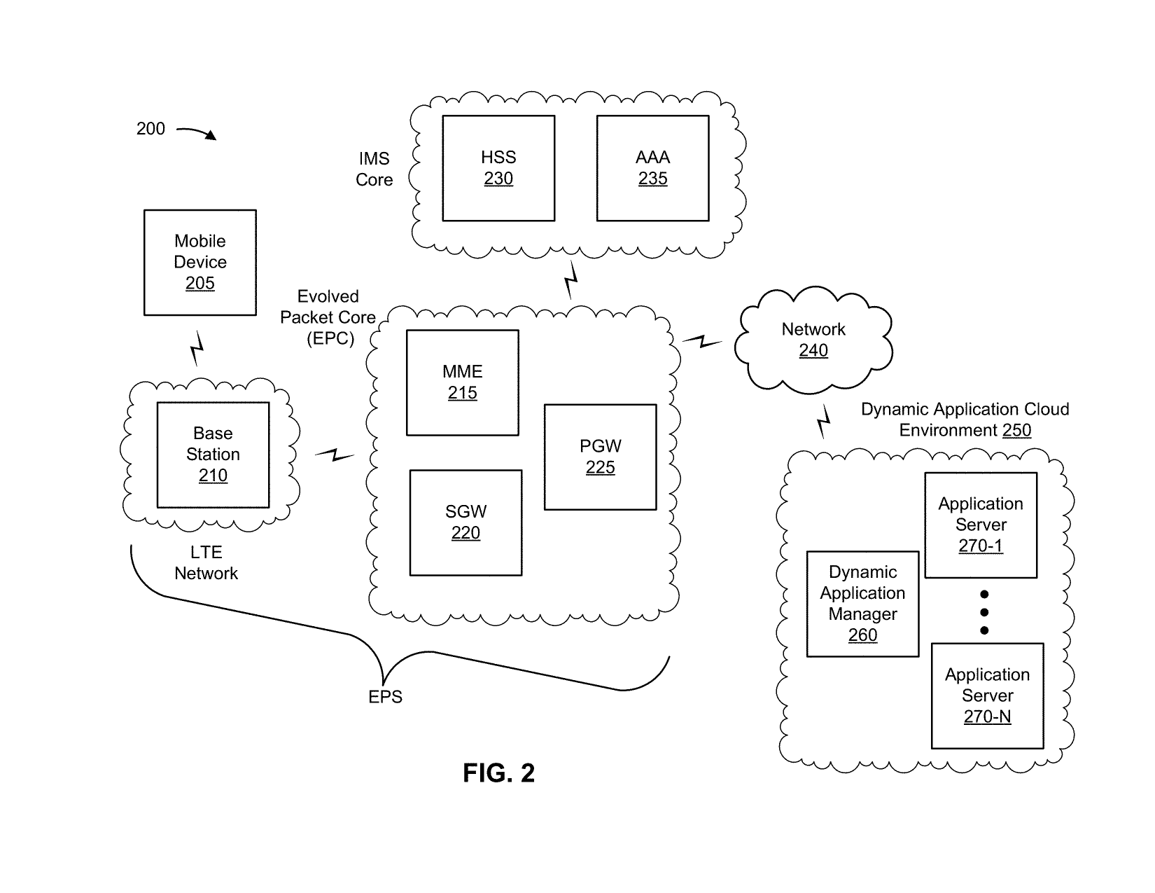

FIG. 2 is a diagram of an example environment 200 in which systems and/or methods, described herein, may be implemented. As shown in FIG. 2, environment 200 may include a mobile device 205; a base station 210; a mobility management entity device (MME) 215; a serving gateway (SGW) 220; a packet data network gateway (PGW) 225; a home subscriber server (HSS) 230; an authentication, authorization, and accounting server (AAA) 235; a network 240; and a dynamic application cloud environment 250 hosting a dynamic application manager 260 and one or more application server 270. Devices of environment 200 may interconnect via wired connections, wireless connections, or a combination of wired and wireless connections.

Some implementations are described herein as being performed within a long term evolution (LTE) network for explanatory purposes. Some implementations may be performed within a network that is not an LTE network, such as a third generation (3G) network, a fourth generation (4G) network, a fifth generation (5G) or new radio (NR) network, and/or the like. For example, in a 5G network, a distributed radio access network (RAN) may include a central unit (CU) and one or more distributed units (DU to provide network connectivity.

Environment 200 may include an evolved packet system (EPS) that includes an LTE network and/or an evolved packet core (EPC) that operate based on a third generation partnership project (3GPP) wireless communication standard. The LTE network may include a radio access network (RAN) that includes one or more base stations 210 that take the form of evolved Node Bs (eNBs) via which mobile device 205 communicates with the EPC. The EPC may include MME 215, SGW 220, and/or PGW 225 that enable mobile device 205 to communicate with network 240 and/or an Internet protocol (IP) multimedia subsystem (IMS) core. The IMS core may include HSS 230 and/or AAA 235, and may manage device registration and authentication, session initiation, etc., associated with mobile devices 205. HSS 230 and/or AAA 235 may reside in the EPC and/or the IMS core.

Mobile device 205 includes one or more devices capable of communicating with base station 210 and/or a network (e.g., network 240). For example, mobile device 205 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, and/or a similar device. Mobile device 205 may send traffic to and/or receive traffic from network 240 (e.g., via base station 210, SGW 220, and/or PGW 225). In some implementations, mobile device 205 corresponds to mobile device 105 shown in FIGS. 1A and 1B.

Base station 210 includes one or more devices capable of transferring traffic, such as audio, video, text, and/or other traffic, destined for and/or received from mobile device 205. In some implementations, base station 210 may include an eNB associated with the LTE network that receives traffic from and/or sends traffic to network 240 via SGW 220 and/or PGW 225. Additionally, or alternatively, one or more base stations 210 may be associated with a RAN that is not associated with the LTE network. Base station 210 may send traffic to and/or receive traffic from mobile device 205 via an air interface. In some implementations, base station 210 may include a small cell base station, such as a base station of a microcell, a picocell, and/or a femtocell.

MME 215 includes one or more devices, such as one or more server devices, capable of managing authentication, activation, deactivation, and/or mobility functions associated with mobile device 205. In some implementations, MME 215 may perform operations relating to authentication of mobile device 205. Additionally, or alternatively, MME 215 may facilitate the selection of a particular SGW 220 and/or a particular PGW 225 to serve traffic to and/or from mobile device 205. MME 215 may perform operations associated with handing off mobile device 205 from a first base station 210 to a second base station 210 when mobile device 205 is transitioning from a first cell associated with the first base station 210 to a second cell associated with the second base station 210. Additionally, or alternatively, MME 215 may select another MME (not pictured), to which mobile device 205 should be handed off (e.g., when mobile device 205 moves out of range of MME 215).

SGW 220 includes one or more devices capable of routing packets. For example, SGW 220 may include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, SGW 220 may aggregate traffic received from one or more base stations 210 associated with the LTE network, and may send the aggregated traffic to network 240 (e.g., via PGW 225) and/or other network devices associated with the EPC and/or the IMS core. SGW 220 may also receive traffic from network 240 and/or other network devices, and may send the received traffic to mobile device 205 via base station 210. Additionally, or alternatively, SGW 220 may perform operations associated with handing off mobile device 205 to and/or from an LTE network.

PGW 225 includes one or more devices capable of providing connectivity for mobile device 205 to external packet data networks (e.g., other than the depicted EPC and/or LTE network). For example, PGW 225 may include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, PGW 225 may aggregate traffic received from one or more SGWs 220, and may send the aggregated traffic to network 240. Additionally, or alternatively, PGW 225 may receive traffic from network 240, and may send the traffic to mobile device 205 via SGW 220 and base station 210. PGW 225 may record data usage information (e.g., byte usage), and may provide the data usage information to AAA 235.

HSS 230 includes one or more devices, such as one or more server devices, capable of managing (e.g., receiving, generating, storing, processing, and/or providing) information associated with mobile device 205. For example, HSS 230 may manage subscription information associated with mobile device 205, such as information that identifies a subscriber profile of a user associated with mobile device 205, information that identifies services and/or applications that are accessible to mobile device 205, location information associated with mobile device 205, a network identifier (e.g., a network address) that identifies mobile device 205, information that identifies a treatment of mobile device 205 (e.g., quality of service information, a quantity of minutes allowed per time period, a quantity of data consumption allowed per time period, etc.), and/or similar information. HSS 230 may provide this information to one or more other devices of environment 200 to support the operations performed by those devices.

AAA 235 includes one or more devices, such as one or more server devices, that perform authentication, authorization, and/or accounting operations for communication sessions associated with mobile device 205. For example, AAA 235 may perform authentication operations for mobile device 205 and/or a user of mobile device 205 (e.g., using one or more credentials), may control access, by mobile device 205, to a service and/or an application (e.g., based on one or more restrictions, such as time-of-day restrictions, location restrictions, single or multiple access restrictions, read/write restrictions, etc.), may track resources consumed by mobile device 205 (e.g., a quantity of voice minutes consumed, a quantity of data consumed, etc.), and/or may perform similar operations.

Network 240 includes one or more wired and/or wireless networks. For example, network 240 may include a cellular network (e.g., an LTE network, a 3G network, a 4G network, a 5G or NR network, a code division multiple access (CDMA) network, etc.), a public land mobile network (PLMN), a wireless local area network (e.g., a Wi-Fi network), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

Dynamic application cloud environment 250 includes an environment that delivers computing as a service, whereby shared resources, services, etc. may be provided to configure dynamic applications for utilization with static applications on mobile device 205. Dynamic application cloud environment 250 may provide computation, software, data access, storage, and/or other services that do not require end-user knowledge of a physical location and configuration of a system and/or a device that delivers the services. In some implementations, Dynamic application cloud environment 250 may host dynamic application manager 260 and one or more application servers 270 using a set of cloud resources. The cloud resources may include compute instances executing in dynamic application cloud environment 250, storage devices provided in dynamic application cloud environment 250, data transfer devices provided by dynamic application cloud environment 250, etc. In some implementations, dynamic application cloud environment 250 may include a group of cloud resources, such as one or more applications, one or more virtual machines, virtualized storage, one or more hypervisors, or the like.

Dynamic application manager 260 includes one or more devices capable of receiving, generating, storing, processing, and/or providing information associated with configuring access to a set of dynamic applications using mobile device 205, which may also provide one or more static applications to a user of mobile device 205. For example, dynamic application manager 260 may include a communication and/or computing device hosted by dynamic application cloud environment 250. In some implementations, dynamic application manager 260 corresponds to dynamic application manager 110 shown in FIGS. 1A and 1B.

Application server 270 includes one or more devices capable of receiving, generating, storing, processing, and/or providing information associated with an application. For example, application server 27 may include a communication and/or computing device hosted by dynamic application cloud environment 250 to provide access to a dynamic application to mobile device 205. In some implementations, application server 270 corresponds to application servers 115 shown in FIGS. 1A and 1B.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

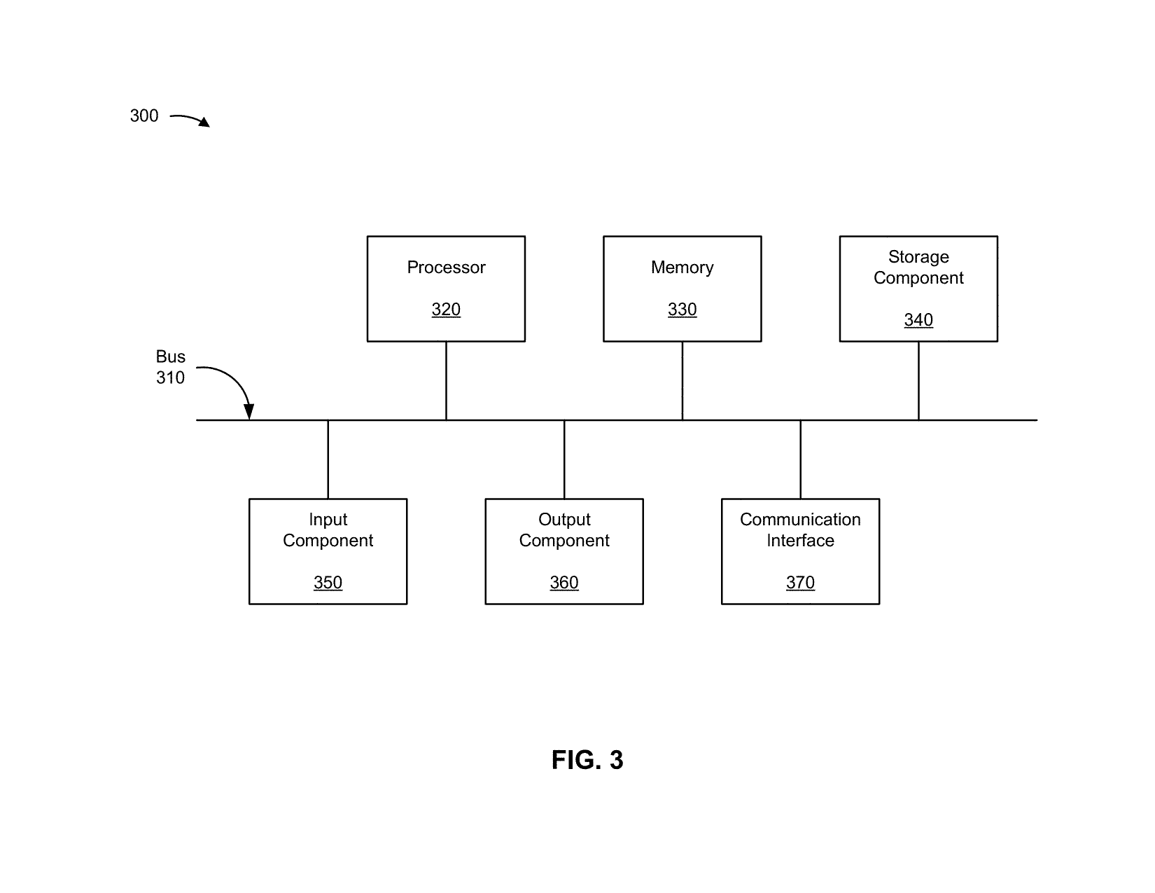

FIG. 3 is a diagram of example components of a device 300. Device 300 may correspond to mobile device 205, base station 210, MME 215, SGW 220, PGW 225, HSS 230, AAA 235, dynamic application cloud environment 250, dynamic application manager 260, and/or application server 270. In some implementations, mobile device 205, base station 210, MME 215, SGW 220, PGW 225, HSS 230, AAA 235, dynamic application cloud environment 250, dynamic application manager 260, and/or application server 270 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

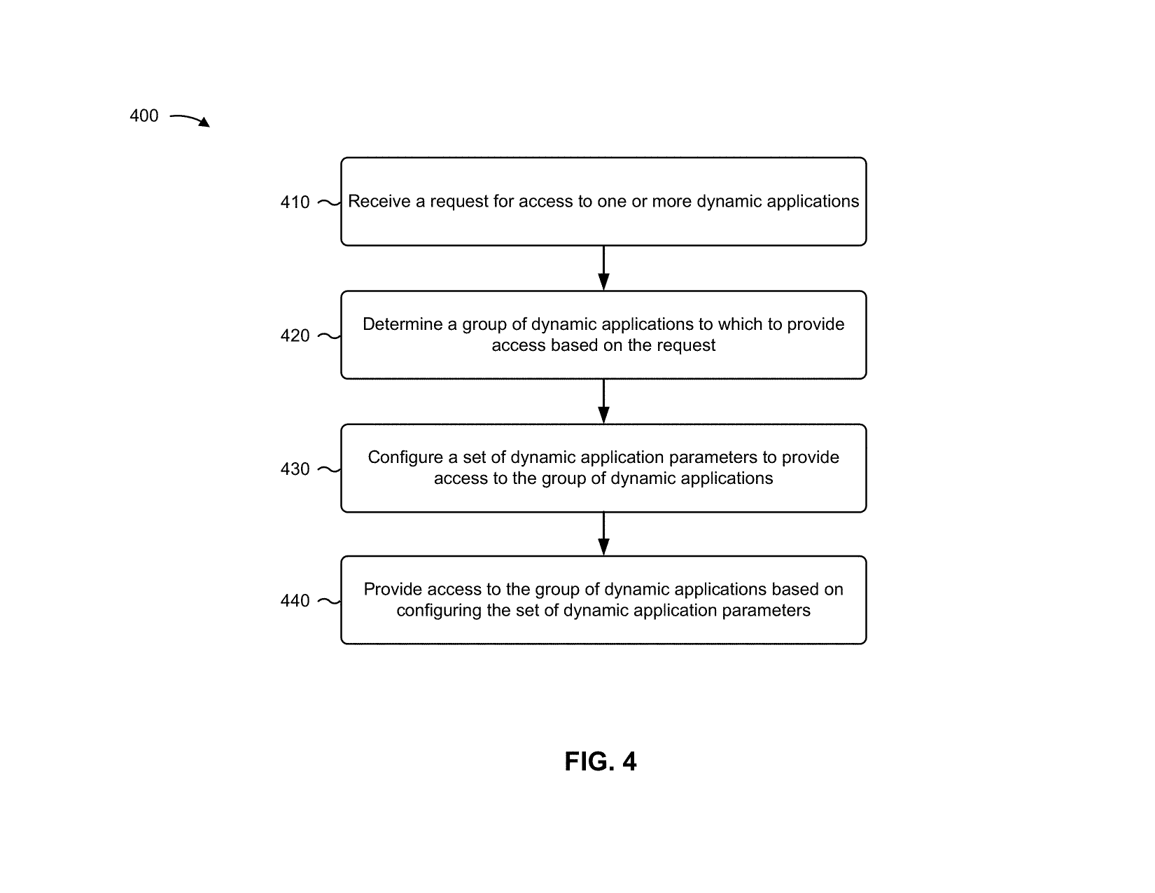

FIG. 4 is a flow chart of an example process 400 for providing access to applications. In some implementations, one or more process blocks of FIG. 4 may be performed by dynamic application manager 260. In some implementations, one or more process blocks of FIG. 4 may be performed by another device or a group of devices separate from or including dynamic application manager 260, such as mobile device 205, base station 210, MME 215, SGW 220, PGW 225, HSS 230, AAA 235, dynamic application cloud environment 250, and application server 270.

As shown in FIG. 4, process 400 may include receiving a request for access to one or more dynamic applications (block 410). For example, dynamic application manager 260 may receive a request for access to one or more dynamic applications. In some implementations, dynamic application manager 260 may receive the request via a Hypertext Markup Language (HTML) connection, via an application programming interface (API) call of an API of dynamic application manager (e.g., a RESTful API), and/or the like.

In some implementations, dynamic application manager 260 may receive the request based on mobile device 205 detecting a trigger. For example, the trigger may include startup of mobile device 205. As another example, the trigger may occur periodically (e.g., every 5 minutes, 10 minutes, 1 hour, etc.). As yet another example, the trigger may be based on network connectivity (e.g., when mobile device 205 first connects to network 240, reconnects to network 240 after a disconnection from network 240, etc.). As still another example, the trigger may include a user request for dynamic applications. As another example, the trigger may include a geographic location change (e.g., a movement by mobile device 205 of a threshold distance, detection of a new geofenced location, detection of a beacon, etc.). As yet another example, the trigger may include proximity to a signal (e.g., detection of a beacon, a radio-frequency identification (RFID) signal, a near-field communication (NFC) signal, a Bluetooth signal, etc.). As an example, the trigger may occur based on operation of a camera of mobile device 205 (e.g., scanning a quick response (QR) code or another type of indicator).

In some implementations, the request for access may include information associated with mobile device 205. For example, the information associated with mobile device 205 may include information identifying mobile device 205 (e.g., a device identifier, a user identifier, etc.), information identifying a capability of mobile device 205 (e.g., a device type, a device operating system, a device memory size, a device processor capability, a device user interface display size, display dimensions, a portion of the display that is to be reserved for system information or static application identification, etc.), information identifying a location of mobile device 205 (e.g., global positioning system (GPS) information, beacon information (identifying a beacon at a particular location)), and/or the like.

As an example, when mobile device 205 detects a beacon at an amusement park, the request may include information identifying the beacon (e.g., to obtain applications relating to the amusement park, such as map application, payment application, augmented reality application, etc.). As another example, when mobile device 205 detects (e.g., via GPS) that a user is in a particular city, the request may include location information identifying the city (e.g., to obtain applications relating to the city, such as subway map, emergency services access application, etc.). In some implementations, the request may include information identifying a percentage of user interface space that is to be allocated to dynamic applications. In this way, dynamic application manager 260 may provide access to fewer applications if less user interface space is available to display the applications, application icons, and/or the like, thereby reducing a utilization of network resources relative to providing access to a preselected quantity of dynamic applications for less than a threshold available user interface space.

In some implementations, mobile device 205 may include static applications stored in memory (e.g., that have been downloaded, preloaded, etc.), and dynamic application manager 260 may provide dynamic applications executing in a cloud environment (e.g., dynamic application cloud environment 250) via a connection of mobile device 205 and dynamic application manager 260. In some implementations, the dynamic applications may be location specific (e.g., targeted to mobile devices at a location). In some implementations, the dynamic applications may be user specific (e.g., targeted to particular users, such as having a simplified child version of an application for users under 18 and a regular version of the application for adult users). In some implementations, the dynamic applications may be device specific. For example, a first type of operating system may use a first version of an application, and a second type of operating system may use a second version of the application. As another example, a first size user interface may use a first version of an application optimized for the first size user interface, and a second size user interface may use a second version of the application optimized for the second size user interface.

In some implementations, dynamic application manager 260 may receive dynamic applications from an application provider (e.g., from an application server 270 operated by an application provider). In this case, the application provider may provide the application for storage in a data structure of dynamic application cloud environment 250. In some implementations, dynamic application manager 260 may receive registration information (e.g., identifying a geofence for providing an application, a type of user for an application, a type of device for an application, a configuration for an application (e.g., a first type of user interface layout for a first user interface size and second type of user interface layout for a second user interface size), and/or the like. In some implementations, dynamic application manager 260 may receive an application update, such as different registration information identifying a different geofence, a different application (e.g., an update, a downgrade, etc.), and/or the like. In this way, application providers may rapidly deploy and/or update applications to mobile devices, rather than having to preload the applications or requiring a new download.

In this way, dynamic application manager 260 may receive a request for access to one or more dynamic applications

As further shown in FIG. 4, process 400 may include determining a group of dynamic applications to which to provide access based on the request (block 420). For example, dynamic application manager 260 may determine a group of dynamic applications to which to provide access based on the request.

In some implementations, dynamic application manager 260 may select the group of dynamic applications from a stored set of dynamic applications. For example, dynamic application manager 260 may provide a submission portal to receive dynamic applications and/or multiple versions of a particular dynamic application (e.g., from an external application server device), and may store received dynamic applications in a data structure (e.g., of an internal application server device local to dynamic application cloud environment 250).

In some implementations, dynamic application manager 260 may determine the group of dynamic applications based on information included in the request. For example, dynamic application manager 260 may select applications configured for a particular user interface size, device type, location, user type, and/or the like. In some implementations, dynamic application manager 260 may determine the group of dynamic applications based on information obtained from a data structure (e.g., stored user information, stored device information, etc.). In some implementations, dynamic application manager 260 may crawl social media to determine user information. For example, dynamic application manager 260 may use machine learning to classify users based on social media information.

In some implementations, dynamic application manager 260 may determine a dynamic application by matching a request to a dynamic application profile. In this case, dynamic application manager 260 may identify a preselected group of dynamic applications based on matching a set of criteria (e.g., user interface size, device type, etc.). In some implementations, dynamic application manager 260 may determine availability of dynamic applications. For example, dynamic application manager 260 may test an application to determine that it is operating correctly, and may select the application to provide as a dynamic application based on determining the availability of the application.

In this way, dynamic application manager 260 may determine a group of dynamic applications to which to provide access based on the request.

As further shown in FIG. 4, process 400 may include configuring a set of dynamic application parameters to provide access to the group of dynamic applications (block 430). For example, dynamic application manager 260 may configure a set of dynamic application parameters to provide access to the group of dynamic applications.

In some implementations, the dynamic application parameters may include a percentage of user interface space to allocate to dynamic applications, a user interface layout to display both dynamic and static applications, order of applications for display, iconography for applications, and/or the like. In some implementations, dynamic application manager 260 may resize icons, text, etc. based on a request (e.g., based on mobile device user interface size).

In some implementations, dynamic application manager 260 may configure access to applications. For example, dynamic application manager 260 may allocate computing resources of dynamic application cloud environment 250 to enable execution of an application. In this way, dynamic application manager 260 may perform a dynamic allocation of resources that is more efficient than static allocation in a cloud server or by a mobile device. In some implementations, dynamic application manager 260 may configure a user interface for access to dynamic applications (e.g., a remote virtual mobile interface). In some implementations, dynamic application manager 260 may configure an HTML connection to provide access to dynamic applications as HTML content. In some implementations, dynamic application manager 260 may select a configuration (e.g., for a particular icon size, a particular display resolution, a particular amount of display space reserved for displaying dynamic applications, and/or the like) from a set of stored configurations. For example, dynamic application manager 260 may receive information identifying a particular type of mobile device 205, and may select a stored configuration corresponding to the particular type of mobile device 205.

In this way, dynamic application manager 260 may configure a set of dynamic application parameters to provide access to the group of dynamic applications.

As further shown in FIG. 4, process 400 may include providing access to the group of dynamic applications based on configuring the set of dynamic application parameters (block 440). For example, dynamic application manager 260 may provide access to the group of dynamic applications based on configuring the set of dynamic application parameters.

In some implementations, dynamic application manager 260 may cause applications to be provided for display on mobile device 205 (e.g., both dynamic applications and static applications in a single, common user interface). In some implementations, dynamic application manager 260 may cause mobile device 205 to use a user interface layout computed by dynamic application manager 260. In some implementations, dynamic application manager 260 may cause mobile device 205 to determine a user interface layout to include both static and dynamic applications. In some implementations, mobile device 205 may identify static and dynamic applications differently in terms of iconography, text identifiers, location in the user interface, and/or the like.

In some implementations, dynamic application manager 260 may cause applications to execute in dynamic application cloud environment 250. In some implementations, dynamic application manager 260 may cause data exchange between mobile device 205 and a cloud computing resource executing a dynamic application to provide access (e.g., a remote virtual mobile interface). In this case, dynamic application manager 260 may cause information identifying user interactions with a user interface of mobile device 205 to be directed to dynamic application cloud environment 250 (e.g., to a dynamic application), and may cause response information to be directed from dynamic cloud environment 250 to mobile device 205. In some implementations, dynamic application manager 260 may cause applications to be downloaded. For example, dynamic application manager 260 may predict a resource utilization (e.g., network resources, bandwidth resources, memory resources, etc.) associated with operating an application as a dynamic application or a static application, and may select to operate the application as a dynamic application or a static application to conserve resources.

In this way, dynamic application manager 260 may configure a set of dynamic application parameters to provide access to the group of dynamic applications.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In this way, dynamic application manager 260 enables seamless deployment of applications by application providers (e.g., OEMs, network operators, etc.) to mobile devices 205 that also store static applications. Moreover, based on providing some applications as dynamic applications, an amount of network traffic, a memory utilization, a device lifecycle time, and/or the like may be reduced relative to providing each application as a static application (e.g., as a preload or a download). Moreover, based on providing some applications as static applications, an amount of network traffic may be reduced relative to providing each application as a dynamic application.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store, or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive a request for access to one or more dynamic applications,
the one or more dynamic applications being executed remote to a mobile device;
determine a dynamic application to which to provide access based on the request;
configure a set of one or more dynamic application parameters to provide access to the dynamic application,
the set of one or more dynamic application parameters being configured based on one or more mobile device parameters relating to the mobile device,
the mobile device being associated with executing one or more static applications; and
provide access to the dynamic application based on configuring the set of one or more dynamic application parameters.

2. The device of claim 1, where the one or more processors, when providing access to the dynamic applications, are to:
cause information identifying the dynamic applications and the one or more static applications to be provided for display by the mobile device in a common user interface.

3. The device of claim 1, where the one or more processors, when receiving the request for access, are to:
receive the request via an application programming interface call.

4. The device of claim 1, where the request for access includes information identifying the one or more mobile device parameters,
the one or more mobile device parameters relating to at least one of:
a display size of the mobile device,
a set of display dimensions of the mobile device,
a portion of a display of the mobile device reserved for displaying information identifying the dynamic application,
a user of the mobile device,
a memory capacity of the mobile device,
a processing capacity of the mobile device, or
a location of the mobile device.

5. The device of claim 1, where the one or more processors, when providing access to the dynamic application, are to:
transmit information identifying an icon corresponding to the dynamic applications to cause the icon to be included with another one or more icons corresponding to the one or more static applications in a common user interface.

6. The device of claim 1, where the one or more processors, when configuring the set of one or more dynamic application parameters, are to:
select, from a plurality of stored user interface configurations, a particular stored user interface configuration for displaying information identifying the dynamic application and the one or more static applications based on a characteristic of at least one of the dynamic applications, the one or more static applications, or the mobile device.

7. The device of claim 1, where the one or more processors, when configuring the set of one or more dynamic application parameters, are to:
dynamically alter at least one of:
a display size of the mobile device,
an icon size, or
a display layout of a user interface of the mobile device.

8. The device of claim 1, where the one or more processors, when providing access to the dynamic application, are to:
cause information identifying one or more user interactions with a user interface of the mobile device to be directed to another device remotely executing the dynamic applications; and
cause response information from the other device to be directed to the mobile device.

9. A non-transitory computer-readable medium storing instructions, the instructions comprising:
one or more instructions that, when executed by one or more processors, cause the one or more processors to:
receive a request for access to one or more dynamic applications,
the one or more dynamic applications being executed remote to a mobile device;
determine a dynamic application to which to provide access based on the request;
configure a set of one or more dynamic application parameters to provide access to the dynamic application,
the set of one or more dynamic application parameters being configured based on one or more static applications to be provided, by the mobile device, with the dynamic application and based on a characteristic of the mobile device,
the one or more static applications being executed by the mobile device; and
provide information identifying the dynamic application based on configuring the set of one or more dynamic application parameters to cause the mobile device to provide, for display, the information identifying the dynamic application.

10. The non-transitory computer-readable medium of claim 9, where the one or more instructions, when executed by the one or more processors, further cause the one or more processors to:
determine a location of the mobile device; and
where the one or more instructions, that cause the one or more processors to determine the dynamic application, cause the one or more processors to:
determine the dynamic application based on the location of the mobile device.

11. The non-transitory computer-readable medium of claim 9, where the one or more instructions, when executed by the one or more processors, further cause the one or more processors to:
determine the one or more static applications to be provided by the mobile device; and
where the one or more instructions, when executed by the one or more processors, further cause the one or more processors to:
determine the dynamic application based on the one or more static applications.

12. The non-transitory computer-readable medium of claim 9, where the one or more instructions, when executed by the one or more processors, cause the one or more processors to:
provide a submission portal to receive the dynamic application;
receive the dynamic application via the submission portal; and
include the dynamic application in the one or more dynamic applications based on receiving the dynamic application via the submission portal.

13. The non-transitory computer-readable medium of claim 9, where the one or more instructions, when executed by the one or more processors, cause the one or more processors to:
identify an external application server associated with providing the dynamic application;
periodically attempt to obtain the dynamic application from the external application server;
store the dynamic application using an internal application server based on successfully obtaining the dynamic application; and
provide access to the dynamic application to the mobile device based on successfully obtaining the dynamic application.

14. The non-transitory computer-readable medium of claim 13, where the one or more instructions, when executed by the one or more processors, further cause the one or more processors to:
replace another dynamic application based on providing access to the dynamic application,
the dynamic application being a version of the other dynamic application.

15. The non-transitory computer-readable medium of claim 9, where the one or more instructions, where the one or more instructions, when executed by the one or more processors, cause the one or more processors to:
determine a type of the mobile device; and
where the one or more instructions, that cause the one or more processors to determine the dynamic application, cause the one or more processors to:
determine the dynamic application based on the type of the mobile device.

16. A method, comprising:
determining, by a device, a group of dynamic applications to which to provide access,
the group of dynamic applications to be executed remote to a mobile device;
configuring, by the device, a set of dynamic application parameters to provide access to the group of dynamic applications,
the set of dynamic application parameters being configured based on one or more static applications to be provided, by the mobile device, with the group of dynamic applications,
the one or more static applications being executed by the mobile device; and
providing, by the device, information identifying the group of dynamic applications based on configuring the set of dynamic application parameters to cause the mobile device to provide, for display, the information identifying the group of dynamic applications.

17. The method of claim 16, further comprising:
determining a particular location of the mobile device at a particular time; and
where determining the group of dynamic applications comprises:
determining the group of dynamic applications based on the particular location.

18. The method of claim 17, where the particular location is a first location and the particular time is a first time; and
further comprising:
determining a second location at a second time after the first time;
determining another group of dynamic applications based on the second location,
the other group of dynamic applications being different from the group of dynamic applications; and
replacing the information identifying the group of dynamic applications with information identifying the other group of dynamic applications.

19. The method of claim 16, further comprising:
allocating computing resources to provide the group of dynamic applications based on determining the group of dynamic applications.

20. The method of claim 16, further comprising:
receiving a request for the group of dynamic applications; and
where determining the group of dynamic applications comprises:
determining the group of dynamic applications based on receiving the request.
